(19) United States
(12) Patent Application Publication
(10) Pub. No.: US 2003/0218624 A1
(43) Pub. Date: Nov. 27, 2003

(54) System and method for organizing digital images

(76) Inventors: Angelica Quintana, Fort Collins, CO (US); Ted Ziemkowski, Loveland, CO (US)

Correspondence Address: HEWLETT-PACKARD COMPANY, Intellectual Property Administration, P.O. Box 272400, Fort Collins, CO, 80527-2400, US

(21) Appl. No.: 10/153,004

(22) Filed: May 22, 2002

(51) Int. Cl. G09G 5/00

(52) U.S. Cl. 345/716

(57) ABSTRACT

A system and method of organizing a plurality of digital images captured by an image capture device is disclosed. The method comprises associating each of the plurality of digital images with respective ones of a plurality of labels in response to a user activating a labeling button disposed on the image capture device and transferring the plurality of digital images to a plurality of folders of a host system based at least in part on the plurality of labels associated therewith, wherein digital images with identical labels are transferred to the same folder of the plurality of folders.

### TECHNICAL FIELD OF THE INVENTION

The present invention relates generally to the field of digital imaging, and more particularly to a system and method for organizing digital images.

### BACKGROUND OF THE INVENTION

Existing image capture devices, such as digital cameras, allow multiple digital images to be stored in a storage medium which is typically part of the image capture device. The digital images are then often transferred to a host system, such as a computer, by coupling the image capture device to the computer and transferring the digital images from the storage medium of the image capture device to a storage medium of the computer. The user may then process the digital images using graphics applications, paste the images in documents, or web pages, send the images via email, etc.

In existing systems, digital images are transferred to a single logical folder, often within a directory of folders organized in the storage medium of the computer. A user then manually organizes and moves the digital images into various other folders based on a classification selected by the user. For example, if the user desires to separate digital images of friends from those of family, the user has to manually create separate folders in the storage medium of the computer and then review each digital image to determine to which folder the image should be moved. This manual process is very tedious and time-consuming.

### SUMMARY OF THE INVENTION

In accordance with an embodiment of the present invention, a method of organizing a plurality of digital images captured by an image capture device is disclosed. The method comprises associating each of the plurality of digital images with respective ones of a plurality of labels in response to a user activating a labeling button disposed on the image capture device and transferring the plurality of digital images to a plurality of folders of a host system based at least in part on the plurality of labels associated therewith, wherein digital images with identical labels are transferred to the same folder of the plurality of folders.

In accordance with another embodiment of the present invention, an image capture device is disclosed. The image capture device comprises a display operable to present a label menu to a user, the label menu comprising a plurality of labels, each of the plurality of labels being selectable by the user; and a labeling button operable to associate a selected label of the plurality of labels with a digital image in response to being activated by the user.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is an elevational view of an image capture device in accordance with an embodiment of the present invention;

FIG. 2 is a flowchart of a method for providing a user-defined label function to an image capture device in accordance with an embodiment of the present invention;

FIGS. 3A and 3B are flowcharts of methods for labeling a digital image in accordance with different embodiments of the present invention; and

FIG. 4 is a flowchart of a method for transferring digital images from an image capture device to multiple locations in a host system in accordance with an embodiment of the present invention.

### DETAILED DESCRIPTION OF THE DRAWINGS

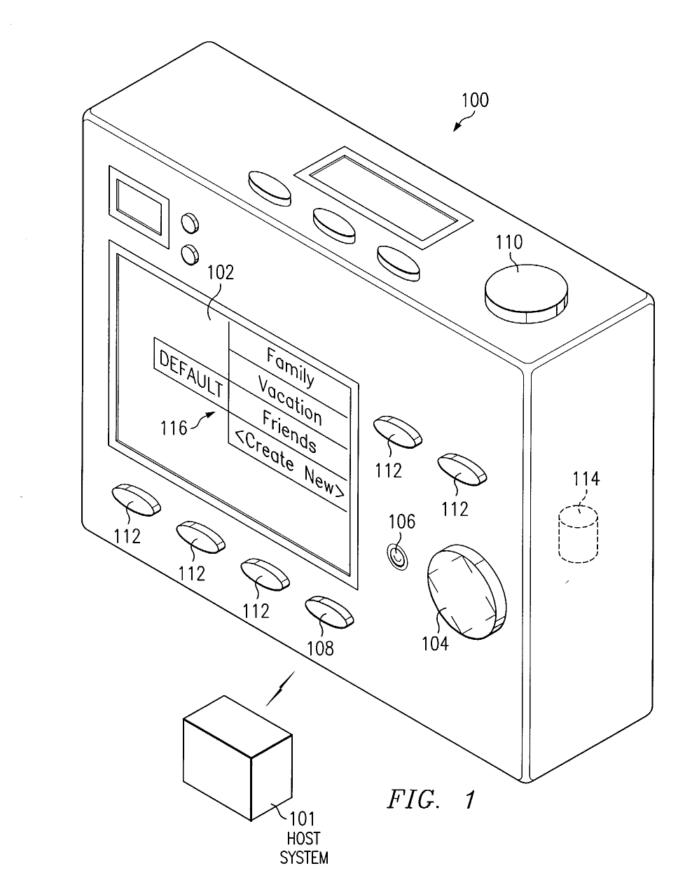

The preferred embodiment of the present invention and its advantages are best understood by referring to FIGS. 1 through 4 of the drawings, like numerals being used for like and corresponding parts of the various drawings.

There is a desire for a system and method for automatically organizing digital images. Accordingly, a method for organizing digital images is disclosed whereby a user may label digital images substantially while capturing the digital images using an image capture device. When the digital images are transferred to a host system, they are automatically saved in separate folders in the host system based at least in part on the label associated with each digital image.

FIG. 1 is an elevational view of an image capture device 100 in accordance with an embodiment of the present invention. Image capture device 100 is preferably a portable device, such as a digital camera or digital video camera. If desired, other devices, such as a portable scanner, a dictaphone, a personal digital assistant (PDA), a multipurpose device, a mobile phone, a laptop, and/or the like, capable of capturing images are also contemplated by the teachings of the present invention.

Image capture device 100 preferably comprises a display 102, a navigation button 104, a toggle switch 106, a labeling button 108, a shutter button 110 and one or more control switches 112. If desired, image capture device 100 may include a storage medium 114.

Display 102 is preferably a Liquid Crystal Display (LCD) and may be used to display text, graphics, and/or the like. If desired, display 102 may be a Cathode Ray Tube (CRT), a Thin Film Transistor (TFT), a Light Emitting Diode (LED), organic polymers, and/or the like now known or later developed. If desired, display 102 may be a touch screen that may be used to control various operations of device 100 and/or to enter information to be stored in device 100. Display 102 may be used to display a label menu 116. Label menu 116 may include a user-defined default label.

Navigation button 104 is used to move a cursor or like indicator according to a direction indicated by the user. Navigation button 104 may be used to control one or more operations of device 100, for example, to make various selections on display 102, to enter text, to navigate label menu 116, to select a label from label menu 116, and/or the like.

Toggle switch 106 is preferably used to toggle image capture device 100 between different modes, for example, a record mode and a review mode. Image capture device 100 may be switched to the record mode to capture one or more images. Image capture device 100 may be switched to the review mode to display one or more already captured images stored in storage medium 114 on display 102.

Labeling button 108 is preferably used to label one or more images in either the record mode or the review mode. A user may activate labeling button 108 in the record mode to specify that the next image captured should be labeled. The user may activate labeling button 108 in the review mode to specify that the image currently displayed on display 102 be labeled. Details of how embodiments of labeling button 108 operate are described below. Image capture device 100 further comprises one or more control switches 112 to control various operations of image capture device 100, such as calling up a menu on display 102, selecting the optimum lighting parameters, selecting image resolution, selecting or deselecting flash, and/or the like.

Storage medium 114 may be a conventional storage medium used for storing information, such as text files, image files and/or the like. Storage medium 114 may also comprise a removable storage medium, for example a floppy disk, a compact disc, a memory stick, a smart media card, a compact flash card, a mini-disk, a micro-drive disk, and/or the like now known or later developed. The user may activate shutter button 110 to capture an image. The captured image may be stored in a digital format in storage medium 114.

Image capture device 100 is capable of communicating with a host system 101. Host system 101 may be any computing device capable of performing at least part of the functionality described herein. For example, host system 101 may be a personal computer, a laptop, a workstation, a PDA, and/or the like now known or later developed.

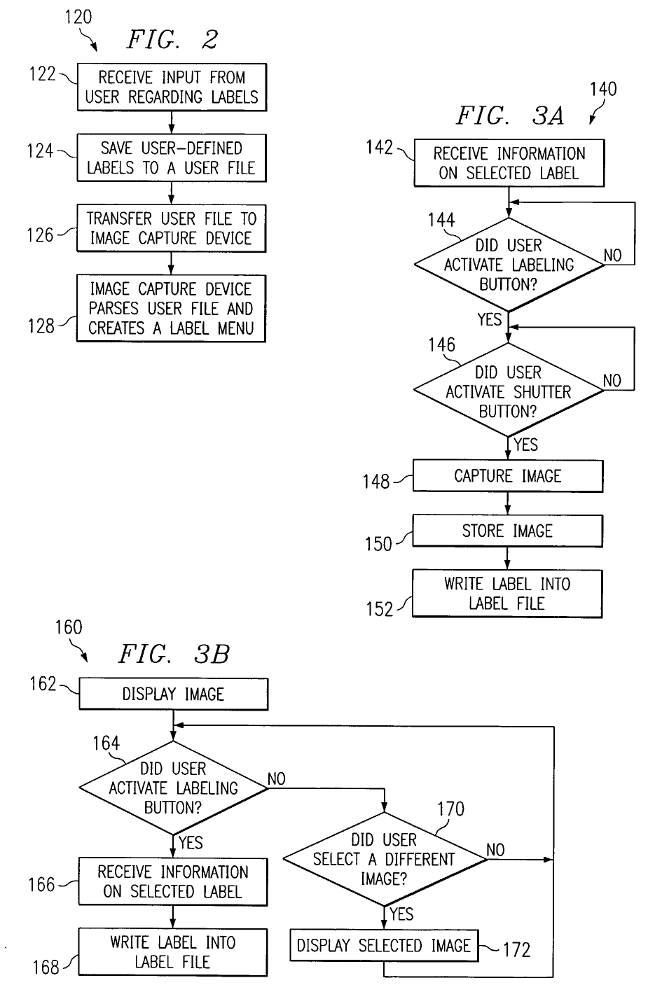

FIG. 2 is a flowchart of a method 120 for providing a user-defined label function to image capture device 100 in accordance with an embodiment of the present invention. The user preferably uses host system 101 to specify the desired labels. In step 122, host system 101 receives the label text from the user. The user may activate an image capture device software residing on host system 101 to specify a plurality of labels to be downloaded into image capture device 100, for example “Family”, “Vacation”, “Friends”, and/or the like. The labels may be specified by the user using any input mechanism now known or later developed. If desired, the user may associate the specified labels with different folders on host system 101 for storing images with the user-defined labels. If the user does not associate the labels with specific folders, then the software automatically creates the folders, as described in more detail below and the images would be stored in folders corresponding to the user-defined labels. In step 124, the user-defined labels are saved to a user file. The user file may be saved in a storage medium which is part of the host computer. If desired, the user file may be saved on a removable storage medium.

In step 126, the user file is transferred to image capture device 100. In a preferred embodiment, image capture device 100 is coupled to host system 101 via a cable and the user file is transferred from host system 101 to image capture device 100 via the cable. If desired, image capture device 100 and host system 101 may be optically linked and the user file transferred from host system 101 to image capture device 100 via the optical link. The transferred user file may be stored in a storage medium 114 of image capture device 100. In an alternative embodiment, in step 126, the user file may be saved on a removable storage medium. The removable storage medium may be used to transfer the user file to image capture device 100. Thus, physical or optical coupling of image capture device 100 to host system 101 may be avoided. In an alternative embodiment, image capture device 100 may comprise an input mechanism that allows the user to create the label definition directly on device 100 itself without using host system 101.

In step 128, image capture device 100 parses the content of the user file and creates a label menu 116. Label menu 116 includes the user-defined labels, for example, “Family”, “Vacation”, “Friends”, and/or the like. Label menu 116 may also include a new menu item, for example a “Create New” menu item, to allow the user to create a new menu item directly in image capture device 100. The user may create a new menu item by navigating to the “Create New” option on label menu 116 and entering a new label. The user may navigate to the “Create New” option by means of navigation button 104. Label menu 116 may be stored on storage medium 114 or on a removable storage medium.

FIG. 3A is a flowchart of a method 140 for labeling a digital image in accordance with an embodiment of the present invention. Method 140 is preferably a method for labeling the digital image when image capture device 100 is operating in the record mode. Image capture device 100 may operate in the record mode in response to the user selecting the record mode by using toggle switch 106. In this mode, the user preferably specifies a label to be used prior to capturing the image.

In step 142, information on a label selected by the user is received. The user may select a label from label menu 116 by navigating to that label using navigation button 104 and selecting that label. If desired, the user may select a label as a default label or the user may even specify that the last selected label be used as the default label. In step 144, a determination is made as to whether the user has activated labeling button 108. If the user has activated labeling button 108, then in step 146, a determination is made as to whether the user has activated shutter button 110. If the user has activated shutter button 110, then in step 148, an image is captured. In step 150, the captured image is stored in storage medium 114. In step 152, the label is written to a label file along with information identifying the captured image. For example, an image index or ID is associated with the user-selected label for the captured image. If the user selected a label prior to activating shutter button 110, then the selected label is written to the label file. Otherwise, the default label may be written to the label file. The label file is a file that associates the labels to the corresponding captured digital images. For each digital image for which the user activated labeling button 108, there is a corresponding entry in the label file associating the label to the digital image. The label file may be stored on storage medium 114.

FIG. 3B is a flowchart of a method 160 for labeling a digital image in accordance with an embodiment of the present invention. Method 160 is preferably a method for labeling the digital image when image capture device 100 is operating in the review mode. Image capture device 100 may operate in the review mode in response to the user selecting the review mode by using toggle switch 106. In this mode, the user reviews images already captured and labels them as desired.

In step 162, one of the captured images is presented on display 102. The user may review the displayed image and determine whether he or she wants to label the image. If the user desires to label the displayed image, he or she may activate labeling button 108. In step 164, a determination is made as to whether the user activated labeling button 108. If the user has activated labeling button 108, then in step 166, information on a selected label is received. The user may select a label from label menu 116 by navigating to that label using navigation button 104 and selecting that label. If desired, the user may select a label as a default label or the user may specify that the last selected label be used as the default label. In step 168, the label is written to the label file along with information identifying the captured image. If the user selected a label, then the selected label is written to the label file. Otherwise, the default label may be written to the label file.

If in step 164, it is determined that the user has not activated labeling button 108, then in step 170, a determination is made as to whether the user has selected a different image. If the user has not selected a different image, then the current image continues to be displayed on display 102. If in step 170, it is determined that the user has selected a different image, then in step 172 the selected image is presented on display 102. The process starting at step 164 may then be executed.

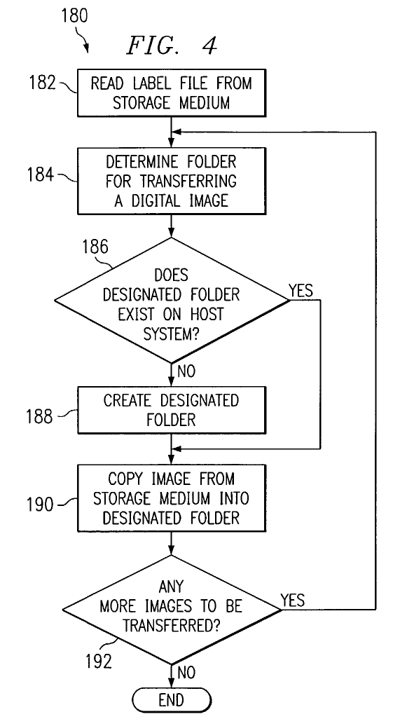

FIG. 4 is a flowchart of a method 180 for transferring digital images from image capture device 100 to multiple locations or folders in host system 101 in accordance with an embodiment of the present invention. In step 182, host system 101 reads the label file from the image capture device. If the label file is stored on storage medium 114, then in this step image capture device 100 is coupled to host system 101 via a cable and the label file is read from storage medium 114. If the label file is stored on a removable storage medium, then the removable storage medium is removed from image capture device 100 and inserted into a device coupled to host system 101 and capable of reading the label file from the removable storage medium. The label file is then read from the removable storage medium.

A process to transfer one or more digital images from the image capture device to host system 101 is then performed. In step 184, the folder in host system 101 to which a digital image is to be transferred is determined. In the preferred embodiment, the label for the digital image associated with an image index or ID is read from the label file. If the user had previously associated a folder with the specified label, then the previously specified folder is designated as the folder in which to copy the digital image. Otherwise, a folder with the same identification as the label read from the label file is designated as the folder in which to copy the digital image. In step 186, a determination is made as to whether the designated folder exists on host system 101. If the designated folder exists, then the image copying process starting at step 190 may be executed. If the designated folder does not exist, then in step 188, the designated folder is automatically created. The image copying process starting at step 190 may then be executed.

In step 192, a determination is made as to whether there are any more images to be transferred to host system 101. If there are more images to be transferred, then the process starting at step 184 may be executed. If there are no more images to be transferred, then the process terminates.

An advantage of an exemplary embodiment of the present invention is that digital images may be labeled substantially simultaneously with the capturing of the digital images. Another advantage of an exemplary embodiment of the present invention is that the captured images may be automatically transferred and sorted to multiple locations or folders in the host system as they are being transferred to the host system. Thus, the disadvantages associated with first storing all the digital images in the same folder on the host system and subsequently manually organizing them into different folders are avoided. Yet another advantage of an exemplary embodiment of the present invention is that the user may label an image simply by activating a labeling button. Yet another advantage of an exemplary embodiment of the present invention is that processing time is reduced due to storing label information in a separate label file.

Although an exemplary embodiment of the present invention has been described herein with reference to an image capture device and a host system, the invention is not so limited. If desired, some or all of the processing performed by the host system may be performed by the image capture device, especially as the processing speed of image capture devices increase. Also, if desired, some or all of the processing performed by the image capture device may be performed by the host system.

What is claimed is:

1. A method of labeling a digital image in an image capture device, comprising:
receiving a label to be associated with the digital image in response to a user input; and
associating said digital image with said label in response to said user activating a labeling button disposed on said image capture device, said associating comprising:
storing said label in a label file; and
storing information associating said label to said digital image in said label file.

2. The method of claim 1, further comprising:
presenting a plurality of predefined labels to said user; and
selecting, by said user, said label from said plurality of predefined labels.

3. The method of claim 1, wherein said receiving further comprises receiving a label from a host system to said image capture device.

4. The method of claim 1, wherein said receiving further comprises receiving a user-defined default label.

5. The method of claim 1, further comprising capturing said digital image.

6. The method of claim 1, further comprising capturing said digital image after receiving the label in response to said user activating a shutter button disposed on said image capture device.

7. The method of claim 6, further comprising storing said digital image in a storage medium.

8. The method of claim 1, further comprising storing said label file in a storage medium.

9. The method of claim 1, further comprising displaying said digital image on a display disposed on said image capture device prior to said associating step.

10. The method of claim 1, further comprising displaying a label menu on a display disposed on said image capture device in response to a request for said label menu by said user.

11. The method of claim 10, further comprising receiving said label in response to selection from said label menu by said user.

12. The method of claim 1, further comprising receiving a plurality of user-defined labels from a host system.

13. The method of claim 12, further comprising creating a label menu from said plurality of user-defined labels.

14. The method of claim 13, further comprising displaying said menu of labels on a display disposed on said image capture device.

15. A method of organizing a plurality of digital images captured by an image capture device, comprising:
associating each of said plurality of digital images with respective ones of a plurality of labels in response to a user activating a labeling button disposed on said image capture device; and
transferring said plurality of digital images to a plurality of folders of a host system based at least in part on said plurality of labels associated therewith, wherein digital images with identical labels are transferred to the same folder of said plurality of folders.

16. The method of claim 15, wherein associating each of said plurality of digital images comprises:
storing a label of said plurality of labels in a label file; and
storing information associating a digital image of said plurality of digital images to said label in said label file in response to said activation of said labeling button by said user.

17. The method of claim 15, wherein transferring said plurality of digital images comprises:
storing said plurality of digital images and said plurality of labels into a removable storage medium;
inserting said removable storage medium into a drive coupled to said host system; and
transferring said plurality of digital images from said removable storage medium to said plurality of folders.

18. The method of claim 15, wherein transferring said plurality of digital images comprises:
storing said plurality of digital images into a storage medium of said image capture device;
coupling said image capture device to said host system; and
transferring said plurality of digital images from said storage medium of said image capture device to said plurality of folders.

19. The method of claim 15, wherein transferring said plurality of digital images further comprises for each of said plurality of digital images to be transferred:
determining a folder in said host system for transferring a digital image of said plurality of digital images; and
copying said digital image to said folder.

20. The method of claim 19, wherein determining said folder in said host system comprises:
retrieving a label of said plurality of labels from a label file for said digital image; and
designating a folder of said plurality of folders corresponding to said retrieved label for receipt of a copy of said digital image.

21. The method of claim 20, further comprising automatically creating said folder corresponding to said retrieved label.

22. An image capture device, comprising:
a display operable to present a label menu to a user, said label menu comprising a plurality of labels, each of said plurality of labels being selectable by said user; and
a labeling button operable to associate a selected label of said plurality of labels with a digital image in response to being activated by said user.

23. The image capture device of claim 22, further comprising a storage medium for storing said plurality of labels and said digital image.

24. The image capture device of claim 23, wherein said storage medium comprises a removable storage medium.

25. The image capture device of claim 22, further comprising a toggle button operable to toggle said image capture device between a record mode and a review mode.

26. The image capture device of claim 22, further comprising a shutter button operable to capture said digital image in response to being activated by said user.

27. A method for labeling a digital image in an image capture device, comprising:
selecting a label based at least in part on a user input;
capturing said digital image in response to a user input; and
associating said digital image with said label, said associating comprising:
storing said label in a label file; and
storing information associating said label to said digital image in said label file.

28. The method of claim 27, wherein said selecting further comprises selecting said label in response to a user activating a labeling button disposed on said image capture device.

29. The method of claim 27, wherein said selecting further comprises selecting said label from a label menu displayed on a display of said image capture device.

30. The method of claim 27, wherein said selecting further comprises selecting said label prior to said capturing said digital image.

31. The method of claim 27, wherein said capturing further comprises capturing said digital image in response to a user activating a shutter button disposed on said image capture device.
